(19) United States
(12) Patent Application Publication
(10) Pub. No.: US 2008/0120546 A1
(43) Pub. Date: May 22, 2008

(54) SYSTEM AND METHOD FOR CREATING INTERACTIVE DIGITAL AUDIO, VIDEO AND SYNCHRONIZED MEDIA PRESENTATIONS

(75) Inventor: Greg Pulier, Beverly Hills, CA (US)

Correspondence Address: KLEINBERG & LERNER, LLP, 2049 CENTURY PARK EAST, SUITE 1080, LOS ANGELES, CA, 90067, US

(73) Assignee: MEDIAPLATFORM ON-DEMAND, INC., Beverly Hills, CA (US)

(21) Appl. No.: 11/562,377

(22) Filed: Nov. 21, 2006

(51) Int. Cl. G06F 3/00

(52) U.S. Cl. 715/716

(57) ABSTRACT

A system and method for creating interactive digital audio, video and synchronized media is disclosed. The invention overcomes the limitations of the prior art by recording the video on a server remotely as it is created, thereby allowing the user to complete the creation process and share the video immediately upon the completion of the creation process. The invention requires virtually no knowledge of complex video editing technologies and enables the user to quickly and easily create multimedia presentations to share including video and images.

### BACKGROUND

1. Field of the Invention

The present invention relates to video and media presentations and more particularly to a system and method for creating interactive digital audio, video and synchronized media presentations.

2. Description of the Related Art

For purposes of this application, the word “video” will be understood to refer to audio, video or audio-visual data interchangeably. Video herein should be understood to be interchangeable with any combination of audio and video data or information. The terms “slide” and “image” are to be understood to be interchangeable. They both refer to digital images, PowerPoint® slides, text documents, or other individually viewable data or data capable of review in sequence. This can include slideshows with transitions between slides or interactive portions that may be active for a period of time.

The term “presentation” or “media presentation” herein will be understood to mean a combination of any type of slide, such as an image, a PowerPoint® presentation slide, still frames from video data, pages in a text document and similar related media with any type of video, streaming data, downloadable audio-visual media, video-based screen capture or images in rapid succession. This combination of slide and “video” as defined herein will be referred to as a “presentation” in the context of this application. In the most general sense presentation refers to a time-based media type driving the synchronized changes of other media types.

There exist systems and methods in the prior art whereby a user may create audio, video and media synchronization. For example, there exist numerous video editors whereby a user may create video. Video creation in the prior art has been somewhat “clunky” and difficult to an average user. Most video creation software or systems require extensive knowledge of the importance of encoding, codecs and file sizes.

Encoding is the process by which audio-video data is “written” in such a way as to be “read” later by a software video viewer. A codec (“coder-decoder”) is a program whereby video may be encoded (and later decoded for viewing). A codec may be understood to coincide with a video or media “format” analogous to a video previously being released on VHS or DVD. They are typically incompatible with one another, but are basically means whereby video data may be stored and replayed for later viewing.

One may describe them as algorithms for storing and then later viewing the video based upon that set of algorithms. There exist, literally, hundreds of varying codecs whereby video may be encoded, compressed (reduced in size for transmission or storage), decompressed or decoded for viewing.

Each codec provides benefits or detriments in relation to other codecs. For example, a particular video codec may provide fairly high-quality video playback, but also create dramatically large file-sizes. Such a codec would be unsuitable for use as “streaming” media over the internet. However, such a codec may be ideal for recording video content to a DVD for providing high-quality video that may be stored in a solid format.

Alternate codecs may be expressly designed for streaming content. These codecs are, in contrast, typically unsuitable for use in recording to DVDs because they are typically low-quality in playback. However, these codecs typically create substantially smaller file sizes and allow for quick and easy playback or download over the internet.

Furthermore, many codecs are specialized and not all codecs are available to all computer users. Often the “best” codecs are not readily available or freely distributed to many users. The best codecs may be codecs that provide high quality video with much smaller file sizes than are normally associated with a particular quality of video.

Alternately, they may provide means for a quick loading buffer of video content, allowing the user's computer time to download the rest of the video as a user watches the buffer portion. The lack of availability of some codecs and the difficulty in acquiring necessary codecs, makes playback of videos using some codecs complicated and difficult for an end-user.

File size, in the field of digital media, as can be understood from the foregoing description of codecs is very important. While the internet is becoming increasingly accustomed to larger and larger file formats, a quality user experience, especially with streaming media or video, still relies upon relatively small file sizes. The larger the file size, the longer load-time a user will experience. Long load times are not conducive to a positive internet user experience.

Recently, the Flash® streaming format, an embedded object-oriented web-software environment, has been used to provide a quick-loading video user experience. The Flash® format is not, strictly speaking, a video format, but it is a format readily capable of streaming. The Flash® format is suitable for low-quality videos in that the file sizes are small and the Flash® format is specifically designed to create quick load-times and to be virtually universally available to any internet user.

Video editors of the prior art typically enable a user to create multiple formats (using numerous codecs) of audio-visual presentations. These formats may vary from large-format high-quality videos suitable for recording to Digital Video Discs (DVDs) to small-format lower-quality audio-visual content suitable for upload to an internet website for download and subsequent review. Choice of codec is only the final difficulty a user of a typical modern video editor faces.

The editing of video is a complex process, selecting time-frames in which to apply edits or cutting portions of video out cleanly. For example, a clean cut requires the user to apply a “fade” effect, at minimum to a cut. Otherwise, the video is disjointed and choppy.

Additionally, as described above, the use of these editors requires somewhat extensive knowledge of video formats, codecs and file sizes to be used effectively. All of this type of knowledge is required in addition to an understanding of recording, the ability to turn on, and the ability to edit videos with which the user is dissatisfied. The method to create video using a computer is still largely foreign to the vast majority of computer users and is a relatively user-unfriendly task.

The sharing of created video content has, in the prior art, added additional complications. A user is required to record the content to a DVD or other media and physically transfer the DVD by mail or by hand to a friend. Alternately, a user would need knowledge of a file transfer protocol (FTP) or a hypertext transfer protocol (HTTP) to upload the video to a web-server for review. Should the user lack knowledge of file formats and attempt to upload a large file, the video sharing would be frustrated.

Furthermore, the upload process takes time. In larger file-formats, the upload process for sharing may make up the most time consuming portion of the video creation and sharing process. Alternate methods exist whereby a user may upload to a video sharing site that converts the video into a video that is able to be shared, but these prior art systems and methods do not provide all of the functionality that a user may desire in sharing video and pictorial content simultaneously in a user-friendly fashion.

While a user may use video editing software, commonly available in the prior art, to create video and then to hard-code synchronization with a media presentation, it is “clunky”, complicated and difficult. In fact, this process is so convoluted to the average computer user, it is virtually never done. It is rare to even find a computer user who works with video on the internet, much less a user who synchronizes slides with that video.

There exist other software products designed for the purpose of synchronizing video to slides. However, these software products retain far too much of the complex functionality of video editing software and the selection of storage or transmission means to be usable by the majority of modern computer users. Even those software products that succeed in providing a reasonably simple experience for authoring audio/video synchronized with slides require a “publishing” phase at the end that usually requires a lengthy upload time following the creation of the presentation. (assuming any reasonable quality, size and length of video).

For these reasons, there presently exists a need for simple means whereby a user may synchronize an audio-visual presentation and pictures or “slides” and then easily share the combined presentation with others without significant waiting periods in the process. The prior art also lacks means for sharing a combined video/pictorial presentation immediately upon the completion of the creation process.

There exists no method in the prior art whereby a user may create an embeddable object for use in web logs (“blogs”) or with proprietary sites such as the MySpace® website. There exists no system or method in the prior art whereby a user may immediately e-mail, upon the completion of a recording being created and synchronized to a series of slides, a link to those with whom the user wishes to share the newly created content.

### SUMMARY OF THE INVENTION

The present invention provides a system and method for creating interactive digital audio, video and synchronized media presentations. In summary, the system and method of this invention allows a user to quickly, easily and intuitively create a combined video and “slide show” presentation. The preferred embodiment of the present invention provides numerous benefits over the prior art.

The system and method of the preferred embodiment of this invention provides the user with software, useable within a web browser, for the recording of audio-visual content (such as a digital video). The video is stored in real-time on a remote server as it is created by the user. The user does not interact with the storage server, upload a video or otherwise worry about file type, storage, video codec choice or similar considerations. The storage is done seamlessly, automatically and invisibly to the user.

Simultaneously with the recording of video content, a user selects at least one picture or other “slide” to describe in the video. The software provides means whereby the video is automatically “marked” to advance slides as the user records the video pertaining to each additional slide. The video is thereby synchronized to a series of slides. A typical use of this invention would be to narrate a series of pictures or slides.

The system and method of this invention further provides means whereby a user may select a particular slide and re-record a video portion associated with that slide. A user may utilize this functionality when a mistake has been made in a portion of the video related to a slide. In the preferred embodiment, seamless transitions are automatically inserted by the software to mask the use of the edit. Additionally, instead of recording video live, the user may select pre-recorded video or create a video of a “screen capture” of a user's actions on a computer screen.

Subsequent to the creation of the simultaneous video and slide-show presentation, a user is immediately presented with a uniform resource locator (URL) link to the media that has been created. This is accomplished by the uploading of video data as it is being captured and recording the video server-side as it is received from the user.

In addition to a URL, an “embedded” link or other web site specific link is provided whereby a user may “embed” the newly created audio-visual presentation in a web site. This link is also created and available immediately, because of the server-side recording methodology of the preferred embodiment of the invention.

It is therefore an object of the present invention to overcome the prior art by the ease of use, lack of video-related knowledge required and the simplicity with which a user may create a video in connection with a slideshow presentation. Additionally, the system and method of this invention provide means whereby a user may easily create, edit and share the created multimedia presentations with limited knowledge of the technical interactions required. Furthermore, the sharing process may take place almost instantaneously because the video is uploaded as it is created.

The novel features which are characteristic of the invention, both as to structure and method of the operation thereof, together with further objects and advantages thereof, will be understood from the following description, considered in connection with the accompanying drawings, in which the preferred embodiment of the invention is illustrated by way of example. It is to be expressly understood, however, that the drawings are for the purpose of illustration and description only, and they are not intended as a definition of the limits of the invention.

### BRIEF DESCRIPTION OF THE DRAWINGS

FIG. 1 is flow chart depicting the steps involved in the operation of the invention from a user perspective.

FIG. 2 is a flow chart depicting the steps involved in the operation of the invention from the server software perspective.

FIG. 3 is a depiction of the login screen of the invention.

FIG. 4 is a depiction of the image selection process of the invention.

FIG. 5 is a depiction of an alternate image selection process of the invention.

FIG. 6 is a depiction of the beginning of the recording process of the invention.

FIG. 7 is a depiction of an ongoing recording process of the invention.

FIG. 8 is a depiction of the editing and sharing process of the invention.

FIG. 9 is a depiction of the system of the invention is shown.

### DETAILED DESCRIPTION OF THE INVENTION

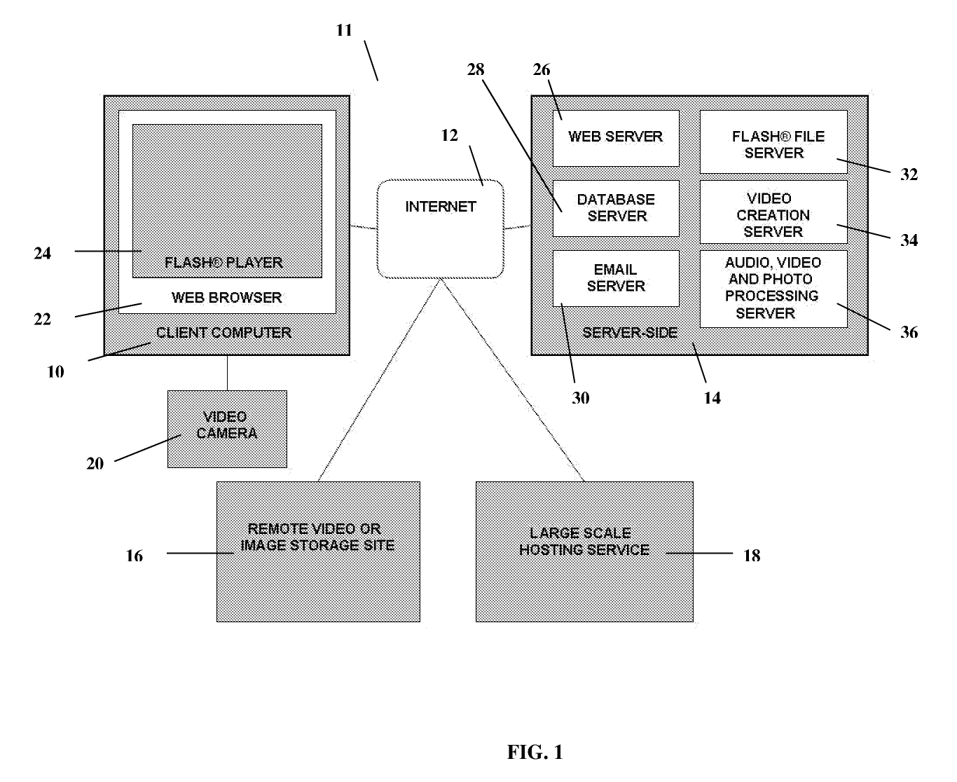

Referring first to FIG. 1, a depiction of the system 11 of the preferred embodiment of the present invention is shown. The first element is the client computer 10. This is the computer of the user as he or she logs into the software of the preferred embodiment. The next element is the communications link 12, in the present example, the internet. It is to be understood that this link 12 need not actually be the internet. Any small or large-scale network or other connection mechanism to the software of this invention will do. However, in the preferred embodiment of this invention, the internet 12 is used.

Next, there is depicted a server-side 14. This is described as a server-side 14, because it may in actuality be a single hardware server, a multiplicity of hardware servers running in the same location or a multiplicity of hardware servers running in multiple locations. There are numerous software servers or programs running on the server-side 14, as will be described, and they may run on one or more hardware servers capable of communication with each other.

Also connected to the internet 12, is the remote video or image storage site 16. This is used by the user to store, remotely from his or her computer, images or video. In the preferred embodiment it may be a Flickr™ or similar service. Alternately, it may be a file transfer protocol (FTP) server or hypertext transfer protocol (HTTP) server.

Also depicted is a large scale hosting service 18. This service can take many forms. One common large scale hosting service is provided by a company known as Akamai Technologies, Inc. These large scale hosting services provide substantial content-caching capability. They are generally designed to ensure that content, especially high-bandwidth content like images and video, are available quickly to an end-user. The use of a large scale hosting service 18 is optional, but is used in the preferred embodiment.

A video camera 20 is also connected to the client computer 10. In the preferred embodiment, this is one of the alternate methods of creating video for use in the presentation. The video camera 20 is attached to the client computer 10 using either wired or wireless means to capture video and upload it to the server-side 14.

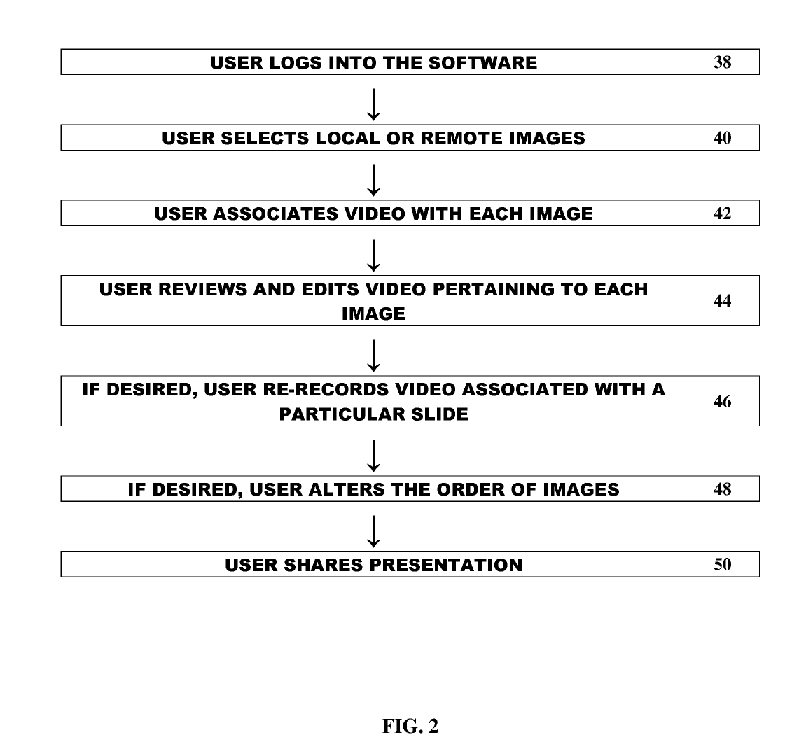

There are, in the preferred embodiment, two elements present on the client computer 10. A first element 22 is a web browser. A second element 24 is a Flash® player. In the preferred embodiment of the invention, a web browser 22 capable of supporting “plugins” is launched on the user's computer and the uniform resource locator (URL) of a site utilizing the system and method of this invention is input. The site then provides an interactive Flash® file that requires the Flash® player 24. The Flash® player 24 is automatically launched and the user begins using the system and method of the invention, in the manner illustrated in FIGS. 2 through 9.

In alternate embodiments, the web browser 22 and the Flash® player 24 may be replaced with one or more client computer 10 software programs. Alternately, the Flash® file served by the site may be replaced by JavaScript, Java, Net, PHP or other suitable programming modules sufficient to accomplish the method described with reference to FIGS. 2 through 9. In the preferred embodiment, however, the Flash® player is used.

The server-side 14 is also made up of numerous elements. A first element is a web server 26. This type of server is well-known in the prior art and is used to respond to requests from a client computer 10 for web-pages. In response, the web server 26 provides files to the client browser 22 that subsequently constructs a webpage viewable by an end user of the client browser 22. The web server 26 is used to provide the files to the client browser 22 used in the invention. Furthermore, the web server 26 (sometimes in connection with the Flash® file server 32) is used to provide the presentation to other individuals with whom a presentation is shared.

Next, a database server 28 is such as a SQL database, an Oracle® database or simply an organized group of text or XML files is employed on the server-side 14. In the preferred embodiment, a SQL database is utilized. The database server 28 is used to keep track of server-side 14 information such as usernames, passwords, XML files, statistics, and project names. The use of a database server 28 for storing this type of data is common in the art. Also shown as a part of the server-side 14 is an e-mail server 30. This is also used as one of the methods of sharing the created presentations. The email server 30 shares the presentations via emails sent out at the behest of the user once a presentation is completed.

Also within the server-side 14 is a Flash® file server 32. In the preferred embodiment, this file server 32 is responsible for serving Flash® files (SWF files) to the user as he or she moves through the presentation creation process. Additionally, this file server 32 is responsible for providing the Flash® files to subsequent viewers of the presentation once it has been shared.

In the preferred embodiment, the viewers of the shared project receive a share of the presentation. The presentation is, as described above, a set of metadata, images and recorded video. In the preferred embodiment, each theme, also described above, is a particular Flash® file (SWF file). These SWF files are designed so as to interact with the metadata to gather the locations in which the video and images are stored. The SWF files also interact with the metadata to advance the image slideshow portion of the presentation as the “markers” indicating that the next image should be displayed occur.

The SWF files are capable of retrieving and displaying both the stored video and the slides or images. In the preferred embodiment, the video and slides are stored on a large scale hosting service 18. In alternate embodiments, the video and images may be stored locally.

Next, a video creation server 34 is shown. This server 34 dedicated to accepting information from a remote location that is intended to be stored as video. It is set up in such a way as to automatically create a pre-determined size and type of video such that the video will be relatively high-quality and yet have a small file size. In the preferred embodiment, this video creation server 34 creates Flash® video (FLV) files. These videos are designed to be played from within Flash® player and to be served by a Flash® file server 32.

Also in the server-side 14 is an audio, video and photo processing server 36. This server 36 may, in fact, be multiple servers, each dedicated to a particular format or file type. In the preferred embodiment, however, it is one server. The audio, video and photo processing server 36 provides functionality sufficient to, for example, create thumbnail images from a remote or locally stored image that is selected by the user for inclusion in the presentation. Additionally, the audio, video and photo processing server 36 is capable of editing video, such as automatically creating transitional cross-fades between edits and performing the edits or “re-recording” of the video itself. Because all of the editing and storage takes place server-side 14, this server is responsible for making these edits and storage take place as instructed by the user.

A user of this system begins by pointing his or her web browser 22 in the client computer 10 to the web server 26 using the software of the present invention. The web server 26 provides, in conjunction with the Flash® server 32 a Flash® file which is used to create and edit the presentation. This file allows the user to select images which are either stored locally or on the remote video or image storage site 16.

The images are immediately uploaded to the server-side 14. In the preferred embodiment, they are stored at the large scale hosting service 18. The user then selects video stored at the remote video or image storage site 16, records video using the video camera 20 or locates video stored on the client computer 10. If video is created, it is done server-side 14, through the use of the video creation server 34 receiving data and storing it in a suitable format for web-based replay. The video is immediately uploaded to the server-side 14. In the preferred embodiment, the video is stored at the large scale hosting service 18.

Video that is stored server-side 14 or at a large scale hosting service 18 may be stored in two ways. The first method is to save a single large file of the video, setting way-points or cues in the associated metadata (described below) to alert the playback software of transitions in slides. Alternately, a series of smaller video files, each associated with a slide, may be created. The second method is used in the preferred embodiment of the present invention. It is better than the first method in that it allows for easier editing or replacement of individual video files associated with each slide on the server-side 14. However, both embodiments are envisioned by the method of the invention.

Next, the user completes adding video associated with each slide in the presentation and performs any edits. The audio, video and photo processing server 36 performs these edits on the server-side 14 according to the user's interactions with the software and, if necessary, in conjunction with the video creation server 34 should additional or alternate video be recorded. Metadata is created and altered according to the user's interactions with the software.

These data or references to data are stored in the database server 38 for subsequent use in sharing. The user then shares the presentation using the email server 30 or the web server 26. A viewer then views the shared presentation which is served by the web server 26 in conjunction with the large scale hosting service 18 over the internet 12.

Turning next to FIG. 2, the steps of the preferred embodiment of the invention from the perspective of a user, is shown as a flowchart. It is to be understood that these steps are intended to be examples. Alternate methods involving additional, fewer or different steps may be employed without varying from the overall scope or intent of the present invention.

In a first step 38, a user logs into the software. In this first or log in step 38, a user provides one of many typical methods of authentication. In the preferred embodiment, a user will utilize a username and password to identify that user to the server 24. In alternate embodiments, usernames, passwords or other indicia of identity may be used alone or in connection with other indicia of identity.

A user's unique identity allows the user to maintain her or himself to the software for purposes of maintaining a history of created presentations. A user may wish to return to a previously created presentation to edit it or to share it with additional individuals.

In a next or selecting step 40, the user selects locally or remotely stored images. To create a video synchronized with slides, a user must select the slides to be used in synchronization with the video.

In alternate embodiments, a user may select a video portion first and associate it with individual or a group of photographs. In yet other alternate embodiments, any type of slides may be used, such as a PowerPoint® presentation, a series of text pages, a series of Portable Document Format (PDFs) files, other sequential or individual file format that may be viewed in series.

In a next or associating step 42, the user associates video to each image. In the preferred embodiment, there are several methods whereby a user may associate video with each image. The first method is to record video using a computer-operated video camera (typically referred to as a “webcam”). The preferred embodiment of the invention provides software running within a web browser that is capable of controlling and operating a webcam. The user utilizes on-screen buttons to record, re-record, edit or delete video for a particular image or slide.

Alternately, in the preferred embodiment, a user may select locally or remotely stored video for association with a particular image or slide. In this alternate, the user selects video that is to be displayed along with a particular image or slide. As yet another alternate in the preferred embodiment, the user may select to “screen capture” video content. In this alternate, the software begins recording activities that take place on a user's screen, such as mouse movements, clicks or other software actions. These actions are recorded as a video and associated with a particular image or slide.

The user next reviews and edits video pertaining to each image in a review and editing step 44. In this step 44, the user may play the video and slideshow presentation to review it. If there is a mistake or the user simply wishes to alter what was previously recorded with relation to a particular slide, then the user may select an image and re-record the video associated with that slide or image 46. Of course, alternately, the user may also select locally or remotely stored video to associate with a particular slide or record computer screen capture video to associate with the slide.

If the user re-records a video for a slide, transitions between the slides on either side are automatically generated (in the preferred embodiment a cross-fade is used) to ease the hard-cut edit in the video. Similar cross-fading is used for the insertion of pre-recorded video or screen capture video. In alternate embodiments, a user may be able to select from several alternates to cross-fading.

Also at this review and editing step 44, the user may alter the order of the images (or slides) 48 displayed. The moving of the images also moves the associated video. If images are moved, the transition cross-fading is automatically applied to the video that has been moved, so as to mask the later edit of the video as a whole.

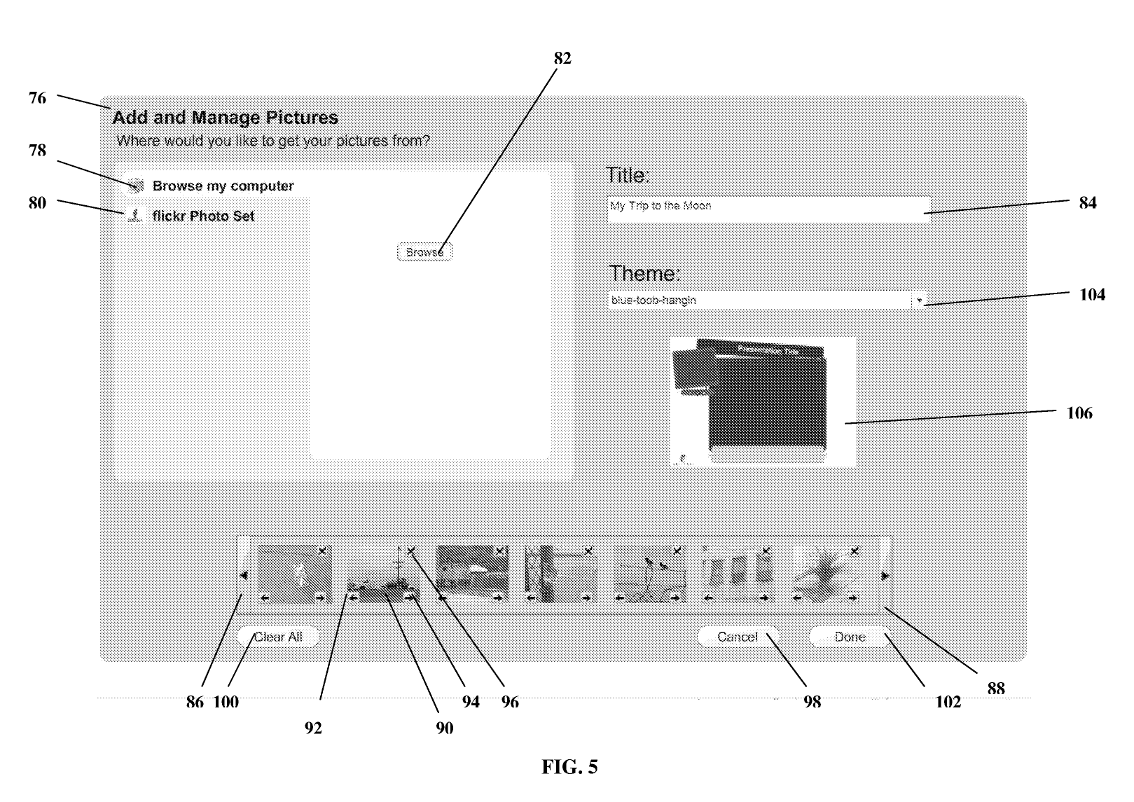

In the preferred embodiment, there are two methods whereby a user may move images, the first being by selecting the image in a “line” of the images that resembles a film frame-by-frame reel (see FIG. 5). The user may then drag and drop the individual image to any location along that reel or alternately, use on screen buttons to move it one frame at a time either to the left or right. The second method employs an overview box depicting the entire (or substantially so) series of images. The user may then select one or more images simultaneously and drag and drop them or otherwise move them as the user desires.

Finally, a user may share the presentation in a sharing step 50. In this sharing step 50, the user is presented with a display of a series of options for the sharing of the completed presentation. In the preferred embodiment, this sharing option is available substantially instantly to the user. As the video is captured, it is immediately transmitted to the remote server. As the order of images or video is edited, the editing takes place server-side and meta data is immediately transmitted.

To the user, none of this transmission is visible. The end result is that virtually the instant that a user has completed the process described above, the presentation is ready to be shared with any number of means. This is a substantial improvement over systems and methods of the prior art in that all prior art inventions provide for these edits and alterations to take place “client side”. Once the user has completed them, they must be uploaded as completed file or files to one or more servers, thereby wasting user time and providing a less user-friendly experience.

In the preferred embodiment, the methods of sharing are through email, a hypertext link and code sufficient for embedding into a blog (“web log”), web page or other proprietary service (such as the Myspace® web site). In alternate embodiments, any number of sharing options will be immediately available, including ftp links, Flash® file links, stand alone application download links and the like.

At this point, a recipient of the shared presentation will click a link to view the file and will see it quickly. The format used by the preferred embodiment is designed, with no user interaction, to be quick-loading and relatively high-quality. Alternately, if the user selects to share through “embedding” a webpage or other service page containing the embedded object will also load quickly, displaying the combined show very soon after page load, thereby also providing a positive quick-loading user experience.

Because there is no upload time, these embedded links and other links are available immediately to an individual with whom the user has shared the link. It is also possible that the sharing maybe done by selecting a portal/search-engine and some metadata by which this portal/search-engine should decide how this particular presentation should be accessible.

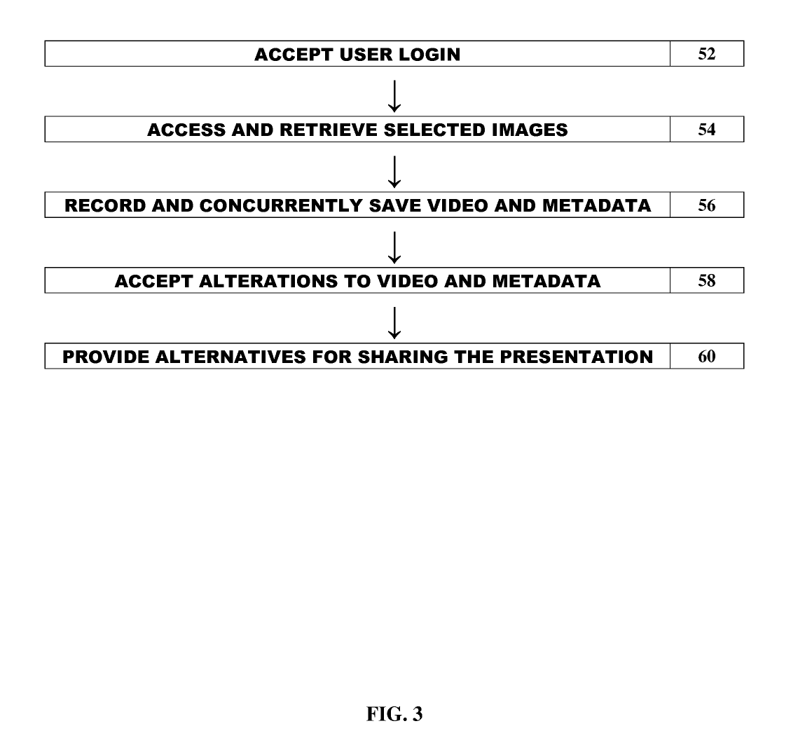

Referring next to FIG. 3, a flowchart depicting the steps in the method of preferred embodiment of the invention are shown from the perspective of the server-side 14. This server is, in the preferred embodiment, the web server 26 capable of interaction with a multiplicity of remote users simultaneously.

Additionally, this server-side 14 has access to large-scale media storage servers and has the capability itself or access to other servers with the capability to edit images and video through the use of “server side” software. In the preferred embodiment, the server also has the capability to create Flash® files that may be viewed in Flash®-enabled web browsers. In alternate embodiments, a podcast™, streaming or downloadable video may be created.

The steps in FIG. 3 are, generally, the steps that the server-side 14 takes in response to user interaction to create the presentation from the video and slides. A first or log in step 52 is to accept the user login. As described with reference to FIG. 2, the login sequence will utilize any number of authentication methods. The method of the preferred embodiment is username and password authentication, but any authentication means may be used.

So far as the server is concerned, as described above, authentication is only important in instances when the user wishes to go back to previously-created presentations and edit or share them with additional people. In theory, no authentication means is necessary if a user only wishes to create a presentation and never edit or share it again. Alternately, a user could simply insert an email address and create the presentation, then the server will email a link to the user for later sharing. In this case, no authentication is necessary.

In a next access and retrieve step 54, the server must access and retrieve selected images. In this access and retrieve step 54, the corresponding user step is step 40, the user selection of local or remote images, the server “finds” the images that have been selected by the user. If the images are locally stored (to the user), then the server downloads those images. If the images are remotely stored, then the server-side 14 downloads those images from the remote location.

In the preferred embodiment, as the server-side 14 downloads the images, it creates two sizes of images through the use of image editing software. In alternate embodiments, any sizes and number of sizes may be used. In the preferred embodiment, the sizes are “thumbnail” size and a “large” size.

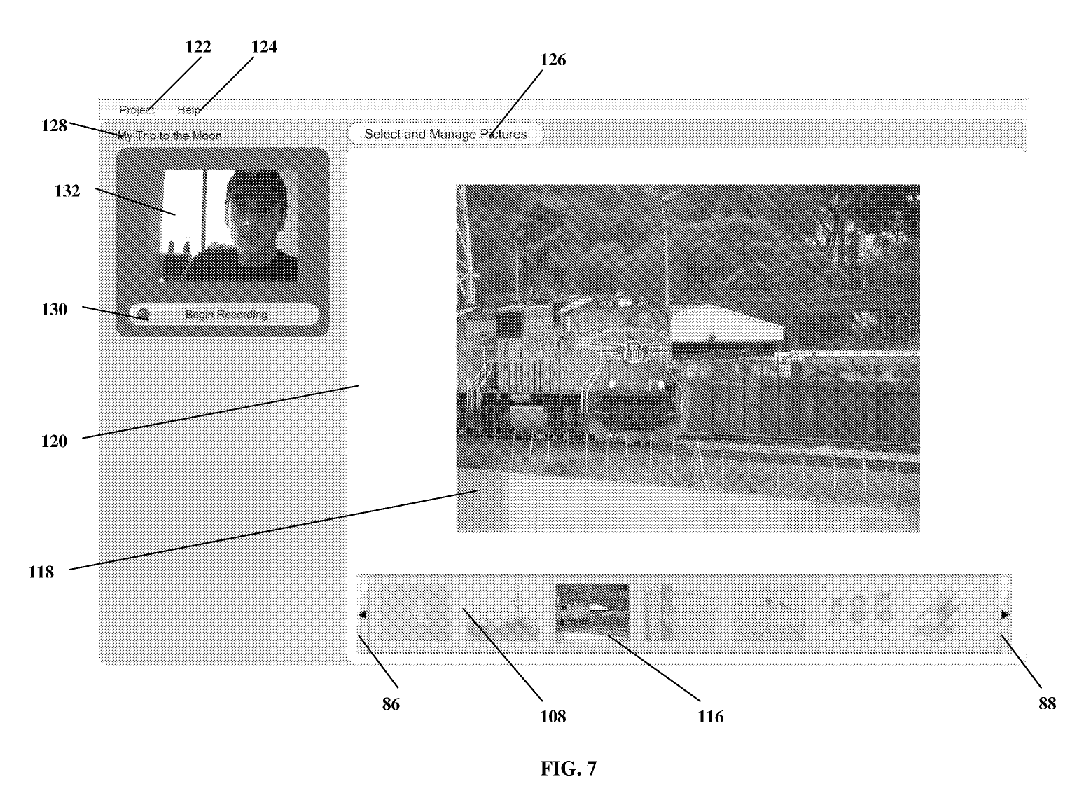

The thumbnail size is an image suitable for display in the reel described with reference to FIG. 2 and FIG. 5 above. The large size is a size suitable for display (See element 118 in FIG. 7). The large size is the size that someone with whom the presentation is shared will see when viewing the presentation.

Next, there is a save and record step 56 in which the server records and concurrently saves video and metadata. In the preferred embodiment of the invention, no video data is stored on the user computer 10. As the user is recording video it is simultaneously uploaded, encoded and stored on the server. This is the process that enables the user, upon completion of the creation process, to immediately share the combined media with other individuals.

This immediate sharing is an advancement over the prior art which requires a substantial delay because of the choice of file format, uploading the video and local storage and editing of the presentation before it is created. If prerecorded video is selected from a remote or local source, the video is quickly uploaded as the user continues to alter the order of images or make any changes. This occurs automatically and without user interaction.

The video is stored on the server along with “markings” of image transitions as the user selects. The video in the preferred embodiment is recorded “per slide” in that a particular portion of the video relates to a particular slide or image. Therefore, when the combined video and slide presentation is created, metadata is also created whereby a slide will be advanced as the video crosses certain playback times or other indicators.

For example, the first 15 seconds of video may be associated with slide one, whereas the next 25 seconds may be associated with slide two. Once 15 seconds of video have elapsed, the slide will automatically advance, as the video plays. This information, in the preferred embodiment, is stored in metadata.

The metadata of the preferred embodiment is a single extensible markup language (XML) file. XML is a file format that uses “tags” to identify portions of information. A reader who receives an XML file will look for these tags and will able to read data from the XML file. XML is well-known in the art and will not be described herein so as to avoid detracting from the scope of the present invention.

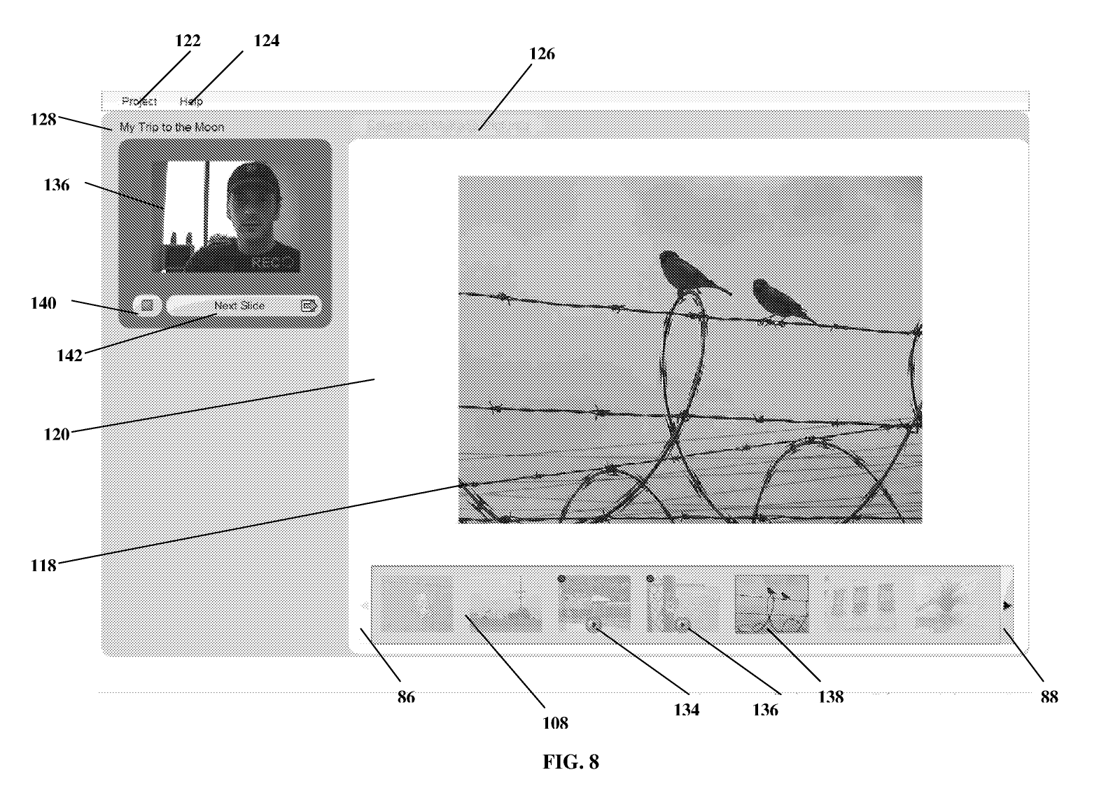

The metadata may take any form, a text file, a hypertext markup language file or encoded portions of the video file itself. However, in the preferred embodiment an XML file is used. This metadata is also served immediately to the remote server and is not stored locally. As the user selects “next slide” (see FIG. 8, element 142), a marking is created in the metadata telling the presentation creation software when to advance to the next image or slide. This metadata is used, server side, to create the subsequent presentation.

In a next, accepting step 58, the server accepts alterations to video and metadata. In this accepting step 58, the server accepts changes to the video and metadata. As described above, the video and metadata are provided immediately to the server as they are created. Similarly, any new video or metadata is also provided immediately to the server.

As a user, for example, swaps the order of images (and thus, the associated video) the server performs the editing of the single video file, cutting it and swapping the locations of the two files. Furthermore, as described above, the server performs, by default, a cross-fading transition of the edits, so as to mask that an edit has taken place. Once the server accepts all the data transmitted as changes, makes all the appropriate edits server-side, records all newly-created or newly-selected video and properly marks transitions from slide to slide in the meta data, it creates an updated sharable file form of that data.

The process of making the shareable file takes part concurrently with steps 56, recording and saving video and metadata, and 58, accepting alterations to video and metadata, respectively. A ready-to-share file is always available at any moment. Therefore, when a user decides he or she is done editing the presentation, the file is immediately available to be shared. As the video is being created and metadata sent, a file is being created that will be available for sharing. As the changes are made, the file is updated in real-time, so that it remains available for sharing. As soon as the final alterations of step 30 are completed, the user may then share the file.

In the preferred embodiment, this sharable file takes the form of a Flash® file. A Flash® file is designed to be quick-downloading and provides built-in scaling of the image. Accordingly, if the user shares the file by embedding it into a web log (“blog”), it will scale to “fit” in the space provided in the blog for it. A Flash® file is also good in that it is typically fairly small in size, designed for streaming and the vast majority of computer users have installed a Flash® Player within their web-browsers.

In alternate embodiments, however, any type of streaming media format could be used. The entire presentation could be saved as a video file in a streaming format such as a Windows® Media Video (WMV) or Quicktime® video. Various formats or file-types may be employed while accomplishing the goal of immediate availability of sharable presentations.

The final or sharing step 60 provides alternates for sharing the presentation. In this sharing step 60, the server provides numerous links and other options for sharing the created presentation. As described above, the presentation is available substantially instantly upon the completion editing and alterations to the video and images. Once the user has completed edits, the server creates sharable links and embeddable objects.

In the preferred embodiment, the user is presented with a hypertext markup language (HTML) link to the created presentation itself. If an individual clicks that link, they are directed to the server itself to view the presentation. Also provided in the preferred embodiment are “embeddable” objects. These are typically HTML code used to “embed” an object in the webpage such that a user may share the presentation by “embedding” it into his or her own webpage.

A subsequent viewer of that webpage will see the presentation as a portion of that web page, though the presentation is created and stored elsewhere. In the preferred embodiment, an object suitable for embedding in a normal webpage and several alternate objects for embedding into proprietary web-pages, such as the Myspace® site are provided.

A user may always return to the site to edit the presentation or further share the presentation with others. A new link and embeddable object tags will be provided the user if edits are made. Additionally, a user may select to start a new presentation, at which point the process described with reference to FIGS. 2 and 3 will repeat.

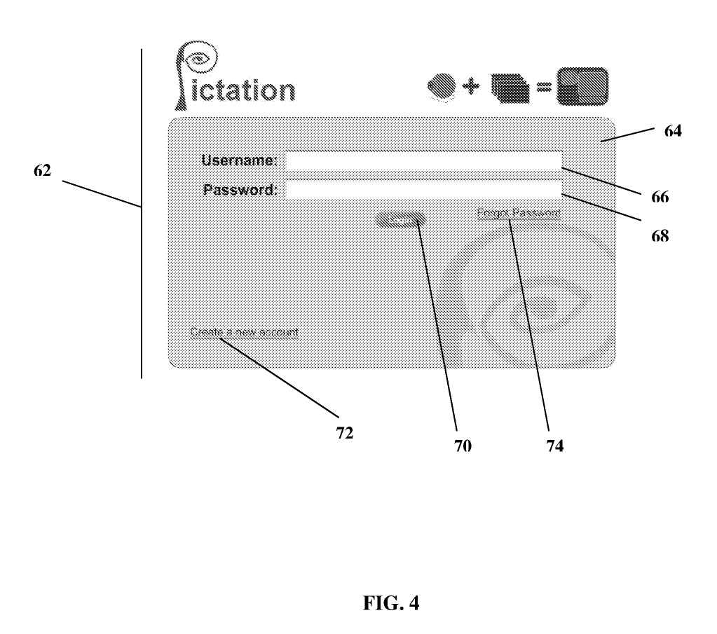

The processes described with reference to FIGS. 2 and 3 may be better understood through the use of an example. FIGS. 4 through 9 show the preferred embodiment of the present invention in use as a presentation is created. These figures will be used to further describe the system and method whereby the invention is practiced.

Referring next to FIG. 4, a login screen 62 of the preferred embodiment of the present invention is shown. This login screen 62 is, in the preferred embodiment, a webpage or portion of a webpage. This screen 62 is similar to many other login screens utilizing authentication methods that are common in the prior art.

In the preferred embodiment, the login screen 62 is depicted alone as the only element in the webpage. Alternately, advertisements or additional content such as other users' presentations or textual content may be displayed in addition to the login screen 62.

A login frame 64 contains all of the elements necessary for creating or logging into a particular user account. The methods for logging in or authentication of a particular user are well-known in the art. The preferred embodiment will be described, but any number of authentication systems and methods may be employed.

First, a username box 66 is provided in which a user inputs a username associated with the user's account. Next, a password box 68 is provided, into which the user inputs the password associated with the particular username. A login button 70 is “pressed” (or activated by default with the “enter” key on the keyboard) once the username box 66 and password box 68 are properly filled with the appropriate information.

Still referring to FIG. 4, as is common in the prior art, a “forgot password” link 74 and a “create new account” link 72 are also provided in the login frame 64. These are used, respectively, for requesting a transmission of a particular username's associated password to a predetermined destination and for creating a new username and password. Methodologies for these actions are well-known in the art and will not be described herein so as to not unduly detract from the system and method of the present invention.

In the present example, a user would utilize the username box 66 to input a username and the password box 68 to input a password in order to login to the site. Current browsers now have the ability to “remember” user names and passwords for each site, if desired by the user. If this browser feature is operable, the user merely brings up the log in screen 62 and the username and password are automatically inserted into their respective boxes.

If the user had forgotten his or her password, the forgot password link 74 would be used. Alternately, if the user were new, the create a new account link 72 would be used to create an account with a username and password with which the user could subsequently login to the site.

Next referring to FIG. 5, an image selection screen is shown. The first two steps, as described with reference to FIGS. 2 and 3, generate a selection page 76 with which images are selected for which video will be created. Pictures may come from a local computer source or one of numerous remote locations. A “browse my computer” tab 78 is used to select one or more images from the user's computer, typically from the hard disk drive.

A “Flickr™ photo set” tab 80 is used to select images stored, currently, at, for example, www.flickr.com, a presently existing website dedicated to image storage and sharing. In addition to these two tabs, in the preferred embodiment of the invention, other tabs (or a pull down menu) can be provided o access any other image sharing site or for access to a user's remotely stored (on another web server) images residing in a remote directory. The use of these alternate tabs (or pull down menu) is substantially similar to that of the Flickr™ photo set tab 80 and therefore are not depicted for purposes of simplicity.

Within the browse my computer tab 78 there is a single “browse” button 82. This browse button 82 is used, as is known in the prior art, to browse a user's computer, typically the hard disk drives, but also any attached CD-ROM drives, DVD drives, Floppy Drives, attached removable media drives and the like. The browse button 82 will allow the user to select an image or group of images for inclusion in a reel at the bottom of the screen (described below).

Once the user has selected images, they will appear in the reel. Using a “title” input box 84, a user may then provide a title for a presentation to be created. This title will be the title that will appear to individuals with whom the presentation is later shared.

The image (or slide) reel 85 is made up of numerous elements. The first two elements are a left directional arrow 86 and a right directional arrow 88. These will move the series of images or slides to the left and right respectively. An example of an image 90 is visible in the reel 85. A series of such images 90 in series make up the reel 85.

Visible within image 90 are a left slide arrow 92 and a right slide arrow 94. These will move the selected image's place in the reel 85 to the left or right respectively. Additionally, an “X” box 96, if actuated, will delete an image 90 from the reel 85. Similarly, a clear all button 100 will delete all images 90 from the reel 85. A “cancel” button 98 will return a user to the login screen 62 and a “done” button 102 will instigate the upload and ordering process for images.

In alternate embodiments, an additional button (nor shown) is provided to the user for managing the order of the images. In this embodiment, the user may click this button and an additional screen appears containing all of the images in a large box.

The user may then select images by clicking on the thumbnails of the image or images and may drag and drop to move the position of the images relative to each other. This embodiment is useful for managing the placement or order of numerous photographs simultaneously.

A user may also select a theme for the presentation. The theme is encapsulated in the area surrounding the video and slide portions of the presentation. A theme selector 104 may be used to select one of numerous themes. As can be seen, the “blue-toob-hangin” theme is selected in FIG. 5. A preview of the theme is depicted in a theme preview box 106.

In alternate embodiments, a series of previews of themes may be seen simultaneously or through the clicking of an associated button. The user may then select the theme by clicking on its preview image, then returning to the add and manage pictures 76 screen of FIG. 5.

A user of the system and method of this invention, after the login process, is presented with this add and manage screen 76. The user then browses his or her computer and selects a group of images 90 using the browse button 82. The images 90 appear in the reel 85 and may be moved using the left and right slide arrows 92, 94, respectively.

The images may be removed by the user by clicking the X box 96 designated for a particular image. The user may select a theme for the presentation using the theme selector 104 and the theme preview 106. Once the user has completed the ordering the slides and selecting a theme, the user may select the done button 102 and move on to the video creation or selection process.

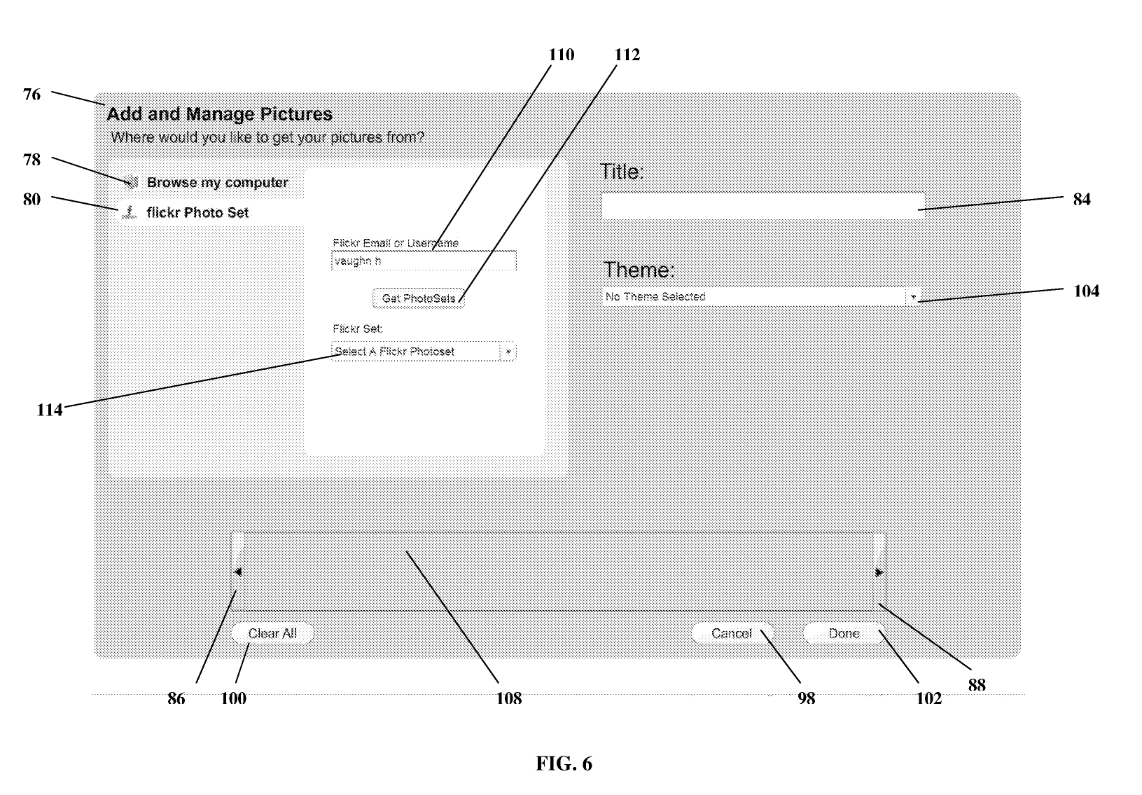

Referring now to FIG. 6, an alternate image selection process is depicted. In this alternate process, a remote cache of images or slides is used as the source for the presentation. The elements visible in FIG. 4 are still depicted. In this case, selecting the Flickr™ photo set tab 80 (deselecting browse my computer tab 78 which, therefore, is no longer visible) brings up a separate log in screen. The add and manage pictures 76 screen is still being displayed and is otherwise the same as the screen depicted in FIG. 5. The theme preview 106 (See FIG. 5) is not depicted because, in this example, no theme has been entered into the theme selector 104.

In this figure, a Flickr™ email or username input box 110 as is required by many on-line sharing services to access images or to access the higher quality images of a particular user. These services, like Flickr™ site, provide web space and easy sharing of images over the web. Flickr™ for example, provides a large amount of space on the web in which to store images and provides means by which these images may be organized and easily shared. A get photosets button 112 will, in conjunction with the username or email being input, provide access to the photosets available on the Flickr™ service.

In the various alternate locations and services available, substantially similar or different methods may be used to access images. For example, if the images are available in an file transfer protocol (FTP) directory, a username and password, in connection with the uniform resource locator (URL) of the FTP server may be required. In other services similar to Flickr™, a username and password may be required. In the preferred embodiment, tabs associated with numerous methods of image selection or upload are available.

Once the user clicks the get photosets button 112, a select a Flickr™ photoset selector 114 is filled with the groups of photosets. A photoset is a term used on the Flickr™ service to designate groups of photos. A user of the Flickr™ service may organize photos into groups of photos as he or she pleases. These groups may be selected in this method.

In tabs associated with similar services or FTP directories, a selector similar to the one provided in the select a Flickr™ photoset selector 114 will be provided. Examples of selectors provided may include select a directory or select a group of images. Once the user selects a photoset, using the select a Flickr™ photoset selector 114, the reel 85 is filled with the images (thumbnails of the images) in that photoset (or directory in alternate tabs) and the user may perform the actions described with reference to FIG. 5 on the images and the reel 85.

For example, a user may select to utilize the Flickr™ photo set tab 80. The user then inputs his username in the Flickr™ email or username input box 110 and clicks the get photosets button 112. The user then selects a photoset using the select a photoset selector 114. The user's selected images will then appear in the reel 85 and the user may move on to the next step, described with reference to FIG. 7.

Referring next to FIG. 7, a next step in the process, a step of recording the video to be included in the presentation is illustrated. Visible, as in the previous screen are the reel 85 and the left and right directional arrows 86, 88. The currently selected slide 116 is also shown in the reel 85. The slides, such as the currently selected slide 116 are the thumbnail size images, whereas a preview image 118 is the full size image that will be seen by individuals with whom the presentation is shared. The preview image pane 120 is the area in which the preview images, such as preview image 118, are shown as the slide-show advances.

There is a select and manage pictures button 126 for returning to the screen depicted in FIGS. 5 and 6, for managing the images that are displayed in the reel 85. Also present are a project menu 122 and a help menu 124. The project menu 122 contains menu items related to altering the title, share methods, and other project-related elements of the presentation. The help menu 124 calls up help documentation related to the use of the system and method of this invention and the website generally. Finally, the title, selected in a title input box 84 (See FIGS. 5 and 6), is displayed in title area 128.

The system and method of this invention provide for the use of video in conjunction with an image or series of images. Those images may be slides or other formats, as described above. The primary method whereby video is provided with reference to the slides is through direct recording. In the preferred embodiment, this process begins on this screen.

The user clicks a “begin recording” button 130 to begin recording video associated with the selected image or slide (such as the currently selected image 116). The video appears in a video screen 132. A typical user will be utilizing a video camera in conjunction with a microphone, either built into the computer, computer monitor or a stand-alone microphone. The user creates video associated with a particular series of slides, beginning with the actuation or a begin recording button 130.

Referring now to FIG. 8, (which shows the screen of FIG. 7 later in time) once the user has clicked the begin recording button 130 (see FIG. 7), the user is immediately presented with the screen visible in this figure. Still present are the reel 85, the title 128, the project menu 122, the help menu 124, the preview pane 120 and the current image 118. The left and right directional arrows 86, 88 are also shown.

Because the user is currently recording, the select and manage pictures button 126 is “grayed out,” not allowing the user to perform that action while recording. The currently selected image is now image 138. Previously recorded images are visible in the reel 85, immediately preceding image 138. It can be ascertained that these images have video associated with them by noticing that they have play buttons 134 and 136, respectively, visible near the bottom of these images. These buttons can be used, immediately, to review in the video pane 132 the video now created, stored and associated (through the use of the metadata described above) with the slide.

Also visible in FIG. 8 are a “stop” button 140 and a “next slide” button 142. The stop button 140 is used to stop recording video for a particular slide or series of slides. The next slide button 142 is used to advance slides as the user is narrating.

The next slide button 142 also sends metadata associated with advancing the slide to the server for the creation of the subsequent presentation. If the user clicks the stop button 142, the recorded video since the last begin recording button 130 click or next slide 142 button click is associated with the currently selected slide, the next slide is selected and video is no longer recorded.

The user may then review previously-created video using the play buttons 106 or 108, respectively. As more and more video is created for each slide, a new play button, similar to elements 134 and 136 is added to each image in the reel 85. Once video is recorded for all slides, play buttons, similar to element 134 and 136 are added to every image in the real 85.

A user of the system and method of this invention as described with reference to FIGS. 7 and 8 would begin recording video by clicking the begin recording button 130. The user then, hits the next slide button 142 each time they have completed recording the video to be associated with a particular slide.

Accordingly, play buttons similar to buttond 134 and 136 would appear for each image in the reel 85 as video associated with them is created. Finally, once a user clicks the stop button 140 or reaches the end of the slides and presses the next slide button 142, video recording would stop and the user may then review and, if he or she desires, re-record video.

In an alternate embodiment, the user may also be presented with an additional button, similar to the button 82 of FIG. 5, whereby the user may select video to be associated with a particular slide or group of slides. In yet another alternate embodiment, the user may be presented with an additional button, whereby a user could record video in the form of a screen capture of the actions being performed, for example with a mouse, on the user's computer screen. The actions and all visible computer results would be recorded and immediately, just as with the recorded video files from the camera, uploaded to the server. The video from either the pre-recorded video or the screen capture would then be associated with a particular slide or slides.

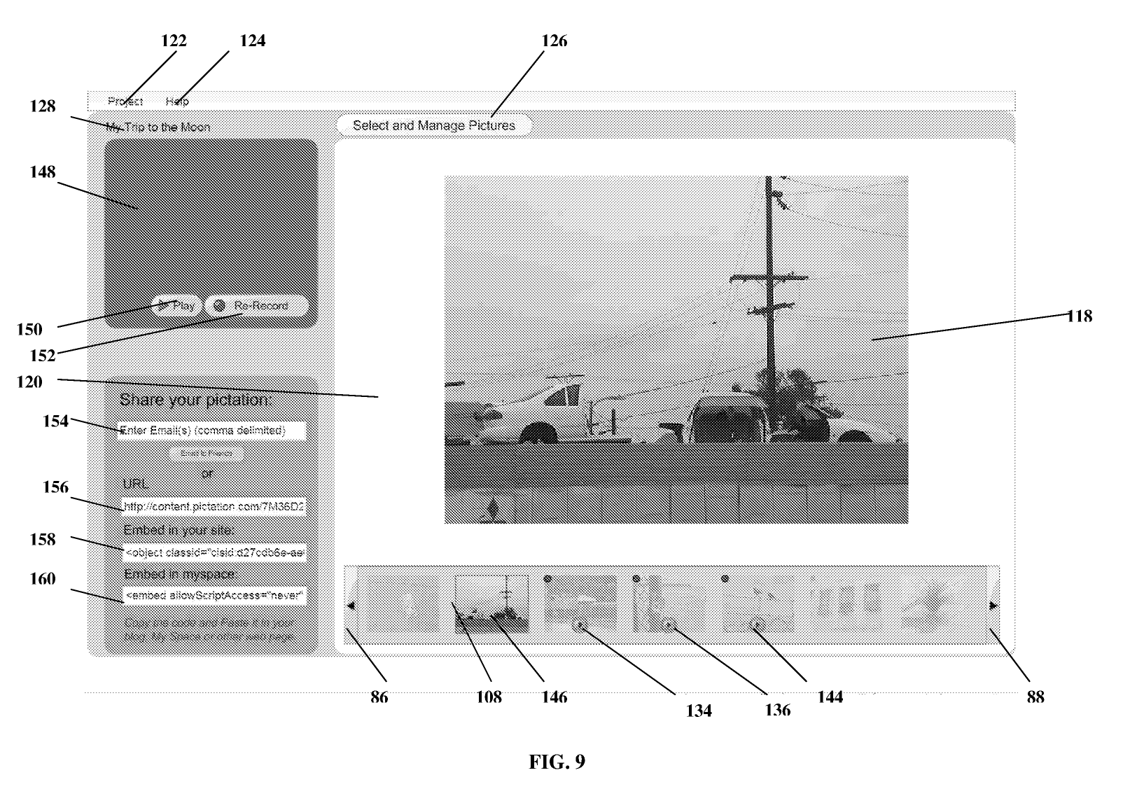

Now referring to FIG. 9, a “sharing” screen of the preferred embodiment of the present invention is depicted. As before, the left and right directional arrows, 86 and 88 respectively, are shown as is the reel 85, along with play buttons 106 and 108. There is now an additional play button 144 associated with an additional image. The currently selected image is 146, as seen in large form in image 118. The user may now, again, click the select and manage pictures button 126, because video is not now, currently, being recorded. The project menu 122 and help menu 124 are also currently displayed.

The video preview 148 is currently blank because video is no longer being recorded. The user may use the play button 150 to play the entire presentation from start to finish, including the associated video so as to preview the presentation before it is shared. Additionally, the user may click the re-record button 152 to re-record all or a portion of the video associated with one or more slides or images. In the preferred embodiment, if a user fails to record video associated with a particular image or slide, the slide will display, alone, for a pre-determine period of time before advancing to the next slide or video and slide presentation.

Still referring to FIG. 9, the user is presented, at this point in the process, with numerous options for ways in which to “share” the created presentation. The options available for sharing in the preferred embodiment are shown in FIG. 9. These include email sharing through the entering of email addresses into an email address textbox 154, the use of linking to the presentation by selecting all of the text in a URL textbox 156 and including that link in an email, web page, instant message or other means for sharing web links.

Alternately the user may choose to “embed” the content in a blog, webpage, MySpace® page or other proprietary site. In the preferred embodiment, the user is presented with object text sufficient to embed the object into a web page or blog in an “embed in your site” textbox 158. Alternately, the user may embed the content in a MySpace® page (which uses a proprietary format) by copying the text in an “embed in myspace” textbox 160 and placing it in the MySpace® page.

A user of the invention creates, uploads or references video for each of the images he or she desires. The user is then presented with options related to the editing or alteration of the video or order or inclusion of slides. At this step, the user is presented with constantly-updated sharing options.

The user may choose at any time to share the presentation by any one of these means. The presentation is, as described above, instantly shared upon request, because all of the video and images are uploaded to the server-side 14 and all editing and alterations occur in the metadata and to the video on the server. The user's friends would review the presentation shortly after creation and sharing, seeing both the video and the advancing slides automatically.

As described above, the video, images and metadata associated with the creation of the presentation are continuously and instantly uploaded as the content is created, selected or altered. Therefore, the instant the user arrives at this share screen, the presentation is available to be shared.

This is a significant advance over the prior art, wherein prior art systems and methods require significant upload and conversion time subsequent to the creation of the presentation. It is a further advancement over the prior art in that it does not require complex knowledge of video file formats, codecs or complex video-creation or encoding software. The user is guided through the process easily by a simple interface.

Accordingly, a system and method for creating interactive digital audio, video and synchronized media is described. It is to be understood that the foregoing description has been made with respect to specific embodiments thereof for illustrative purposes only. The overall spirit and scope of the present invention is limited only by the following claims, as defined in the foregoing description.

What is claimed is:

1. A method for creating interactive digital audio, video and synchronized media, comprising the steps of:
selecting at least one slide;
correlating a first video portion with said at least one slide to thereby create a multimedia presentation;
recording said first video portion to a server concurrently with said correlating step; and
providing means for sharing said multimedia presentation with others using a computer network.

2. The method of claim 1 wherein said selecting step includes selecting and uploading images from a user's computer.

3. The method of claim 1, wherein said selecting step includes selecting images from a computer network repository.

4. The method of claim 1, wherein said correlating step includes selecting video from a user's computer.

5. The method of claim 1, wherein said correlating step includes selecting video from a computer network repository.

6. The method of claim 1, wherein said correlating step includes recording video from a video camera attached to a user's computer.

7. The method of claim 1, wherein said recording step includes simultaneously copying said correlated video to said server along with data sufficient to identify said video portion as correlated to said at least one slide.

8. The method of claim 1, wherein said sharing step comprises at least one of the following:
a) providing an electronic mail link to said multimedia presentation;
b) providing code useful for embedding an object including said multimedia presentation in another web page; or
c) providing a universal resource locator link to said multimedia presentation.

9. The method of claim 1, wherein said slides are digital images.

10. The method of claim 1, wherein said slides are PowerPoint® slides.

11. The method of claim 1, further comprising the additional step, following the recording step, of altering the order of slides and corresponding video.

12. The method of claim 1, further comprising the additional steps, following the recording step, of:
correlating a second video portion with said at least one slide to create a multimedia presentation; and
recording said second video portion to a server concurrently with said correlating step, thereby replacing said first video portion.

13. The method of claim 1, wherein said first video portion is a part of a larger single video file.

14. The method of claim 1, wherein said first video portion is one of a series of small video files.

15. A system for creating interactive digital audio, video and synchronized media, comprising:
a user computer for selecting slides and video;
a network, connected to said user computer, for transmitting said slides and video; and
at least one server, connected to said network, for storing images, recording video as it is created and metadata.

16. The system of claim 15, wherein said user computer is connected to a video camera.

17. The system of claim 15, wherein said user computer includes a web browser.

18. The system of claim 15, wherein said user computer includes a Flash® player.

19. The system of claim 15, wherein said network is the internet.

20. The system of claim 15, wherein said at least one server is designed in such a way that it is capable of receiving audio and video data immediately upon recording or selection and storing said data as digital audio-video files.

21. The system of claim 15, wherein said at least one server, includes at least one of the following:
a) a web server, connected to said network;
b) a database server, connected to said network;
c) an email server, connected to said network;
d) a Flash® file server, connected to said network;
e) a video creation server, connected to said network;
f) an audio, video and photo processing server, connected to said network; or
g) large scale hosting service, connected to said network.

22. The system for creating interactive digital audio, video and synchronized media, comprising:
a user computer for selecting slides and video;
a network, connected to said user computer, for transmitting said slides and video; and
at least one server, connected to said network, for storing images, recording video as it is created and storing metadata, wherein said at least one server, includes at least one of the following:
a) a web server, connected to said network;
b) a database server, connected to said network;
c) an email server, connected to said network;
d) a Flash® file server, connected to said network;
e) a video creation server, connected to said network;
f) an audio, video and photo processing server, connected to said network; or
g) large scale hosting service, connected to said network.

23. The method for creating interactive digital audio, video and synchronized media, comprising the steps of:
retrieving a selected image;
recording video corresponding to said selected image, and thereby creating a multimedia presentation;
accepting alterations to said selected image or to said video, to thereby alter said multimedia presentation; and
providing alternatives for sharing said multimedia presentation.
